(19) United States
(12) Patent Application Publication
(10) Pub. No.: US 2025/0006420 A1
(43) Pub. Date: Jan. 2, 2025

(54) INDUCTOR

(71) Applicant: Panasonic Intellectual Property Management Co., Ltd., Osaka (JP)

(72) Inventors: Mutsuyasu OTSUBO, Hyogo (JP); Ryotaro TSUGAWA, Hyogo (JP)

(73) Assignee: Panasonic Intellectual Property Management Co., Ltd., Osaka (JP)

(21) Appl. No.: 18/697,892

(22) PCT Filed: Sep. 13, 2022
(86) PCT No.: PCT/JP2022/034167

§ 371 Date: Apr. 2, 2024

(30) Foreign Application Priority Data
Oct. 20, 2021 (JP) 2021-171887

(51) Int. Cl. H01F 27/29; H01F 27/30

(52) U.S. Cl. CPC H01F 27/292; H01F 27/306

(57) ABSTRACT

An inductor includes: a magnetic core that includes side surfaces; a coil element that includes a drawing portion which is drawn from the side surface to the outside of the magnetic core; and an electrode member that is plate-shaped, disposed on the side surface and a bottom surface, and electrically connected to the coil element, the magnetic core includes a projection that protrudes in a direction perpendicular to at least one of the side surface or a top surface and a recess that surrounds the projection and is recessed more inward of the magnetic core than the projection, and the electrode member includes a locking portion that includes an opening which penetrates, according to the projection, the electrode member in the direction of thickness of the electrode member, and the locking portion enters the recess to be locked to a locking surface connecting the projection and the recess.

### TECHNICAL FIELD

The present disclosure relates to inductors.

### BACKGROUND ART

Inductors which are passive elements for storing electrical energy as magnetic energy are used, for example, in DC-DC converter devices and the like in order to increase and decrease a power supply voltage and to smooth a direct current. The inductor is mounted, for example, on the surface of a circuit board or the like. For example, Patent Literature (PTL) 1 discloses an inductor which includes: a main body that includes a magnetic material; a coil element that is disposed inside the main body; and a terminal fitting that is connected to the coil element. In the inductor disclosed in PTL 1, the terminal fitting is attached to the main body using an adhesive, and the terminal fitting and a tip of the coil element exposed from the main body are welded.

### CITATION LIST

### Patent Literature

[PTL 1] Japanese Unexamined Patent Application Publication No. 2011-243685

### SUMMARY OF INVENTION

### Technical Problem

In a conventional inductor, it is likely that depending on the usage environment, the reliability of the connection of an electrode member serving as a terminal fitting and a magnetic core is low, and thus the reliability of the inductor is low. In view of the foregoing, an object of the present disclosure is to enhance the reliability of an inductor.

### Solution to Problem

An inductor according to an aspect of the present disclosure includes: a magnetic core that includes a magnetic material, a bottom surface, a top surface, and a side surface connected to the bottom surface and the top surface; a coil element that includes a coil which is embedded in the magnetic core and a drawing portion which is connected to an end of the coil and is drawn from the side surface to an outside of the magnetic core; and an electrode member that is plate-shaped, disposed on the side surface and the bottom surface, and electrically connected to the coil element via the drawing portion, the magnetic core includes a projection that protrudes in a direction perpendicular to at least one of the side surface or the top surface and a recess that surrounds the projection and is recessed more inward of the magnetic core than the projection, and the electrode member includes a locking portion that includes an opening which penetrates, in accordance with the projection, the electrode member in a direction of thickness of the electrode member, and the locking portion enters the recess to be locked to a locking surface connecting the projection and the recess.

### Advantageous Effects of Invention

According to the present disclosure, it is possible to enhance the reliability of an inductor.

### BRIEF DESCRIPTION OF DRAWINGS

FIG. 1 is a first perspective view of an inductor according to an embodiment.

FIG. 2 is a second perspective view of the inductor according to the embodiment.

FIG. 3 is a top view of a part of the inductor according to the embodiment.

FIG. 4 is a side view of a part of the inductor according to the embodiment.

FIG. 5 is another side view of a part of the inductor according to the embodiment.

FIG. 6 is a diagram illustrating a projection in an inductor according to a variation of the embodiment.

### DESCRIPTION OF EMBODIMENTS

### (Circumstances Leading to the Present Disclosure)

As in PTL 1 described above, in a structure where the terminal fitting is fixed to the main body using only the adhesive, a relatively heavy magnetic core is shaken by vibration, and thus the magnetic core is disconnected from an electrode member soldered to a circuit board, with the result that a welded part may also be disconnected.

In order to enhance the reliability of an inductor, the present disclosure provides the following configuration. An embodiment will be more specifically described below with reference to drawings.

The embodiment described below indicates a specific example of the present disclosure. Numerical values, shapes, materials, constituent elements, the arrangement and connection of the constituent elements, steps, the order of the steps, and the like shown in the following embodiment are examples, and are not intended to limit the present disclosure. Among the constituent elements in the following embodiment, constituent elements which are not recited in the independent claim are described as optional constituent elements.

In the present disclosure, terms such as parallel which indicate relationships between elements, terms such as a rectangular parallelepiped which indicate the shapes of elements, and numerical values are expressions which not only indicate exact meanings but also indicate substantially equivalent ranges such as a range including a several percent difference.

The drawings are schematic views in which emphasis, omissions, or ratio adjustments are made as necessary to indicate the present disclosure, and are not exactly shown, with the result that shapes, positional relationships, and ratios in the drawings may be different from actual shapes, positional relationships, and ratios. In the drawings, substantially the same configurations are identified with the same reference signs, and repeated description may be omitted or simplified.

In the drawings, an X axis, a Y axis, and a Z axis indicating three directions orthogonal to each other are shown, and they are used for illustrating these axes and axis directions along the axes as necessary. The axes are provided for illustration, and are not intended to limit the direction in which the inductor is used and the posture of the inductor.

In the present specification, terms such as a “top surface” and a “bottom surface” in the configuration of the inductor do not indicate a top surface (surface on a vertically upward side) and a bottom surface (surface on a vertically downward side) in absolute spatial perception, and are used to specify the relative positional relationship of the constituent elements of the inductor.

### EMBODIMENT

### [Configuration]

The configuration of an inductor according to the embodiment will be described. The inductor is a passive element which stores electrical energy flowing through a coil element as magnetic energy.

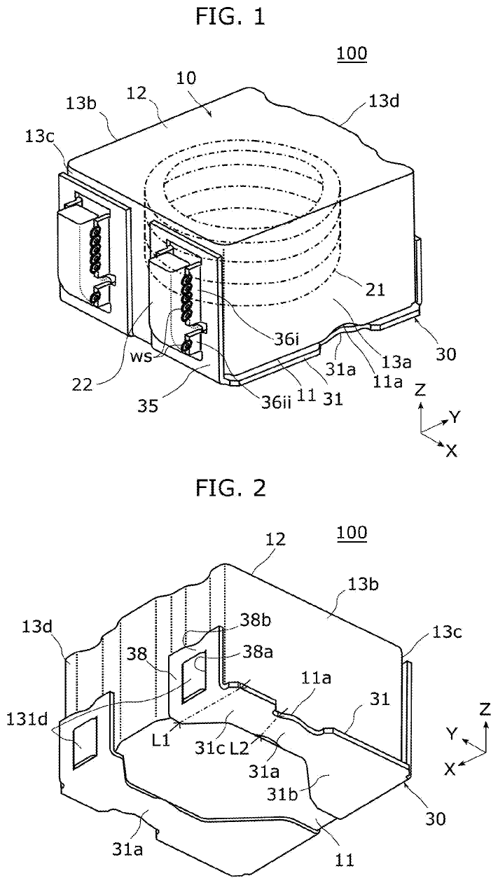

FIG. 1 is a first perspective view when the inductor according to the embodiment is viewed from the side of a top surface. FIG. 2 is a second perspective view when the inductor shown in FIG. 1 is viewed from the side of a bottom surface.

As shown in FIGS. 1 and 2, inductor 100 includes magnetic core 10, a coil element which includes coil 21 and drawing portion 22, electrode member 30 which is an external terminal, a connection portion which connects drawing portion 22 and electrode member 30.

Although a half of inductor 100 on the positive side of the X axis will be mainly described below, a half of inductor 100 on the negative side of the X axis has the same structure as the half of inductor 100 on the positive side of the X axis, and thus the same description is applied.

The approximate external shape of inductor 100 is determined, for example, by the shape of magnetic core 10 which is a powder compacting magnetic core in the shape of a rectangular parallelepiped. Magnetic core 10 can be formed in any shape by forming. In other words, inductor 100 in any shape can be realized by the shape of magnetic core 10 during forming. In magnetic core 10 of the present embodiment, for example, a dimension in an X axis direction is greater than or equal to 17 mm, a dimension in a Y axis direction is greater than or equal to 17 mm, and a dimension in a Z axis direction is greater than or equal to 7 mm.

Magnetic core 10 is an outer shell part of inductor 100, and covers a part (coil 21) of the coil element. Magnetic core 10 includes a magnetic material, and is, for example, a powder compacting magnetic core made of a metallic magnetic powder, a resin material and the like. Magnetic core 10 may be formed using a magnetic material. As the magnetic material, ferrite may be used or another magnetic material may be used. For the metallic magnetic powder, a particulate material having a predetermined elemental composition such as a Fe—Si—Al system, a Fe—Si system, a Fe—Si—Cr system, or a Fe—Si—Cr—B system is used. As the resin material, a material such as a silicone resin is selected which can retain a certain shape by binding the particles of the metallic magnetic powder while insulating areas between the particles of the metallic magnetic powder.

Magnetic core 10 is in the shape of, for example, a rectangular parallelepiped. Magnetic core 10 includes bottom surface 11, top surface 12 opposite bottom surface 11, and four side surfaces 13a, 13b, 13c, and 13d which connect to bottom surface 11 and top surface 12. Side surfaces 13a and 13b are aligned in the X axis direction and are opposite each other. Side surface 13c (also referred to as a second side surface) and side surface 13d (also referred to as a first side surface) are aligned in the Y axis direction and are opposite each other. Bottom surface 11, top surface 12, and side surfaces 13a, 13b, 13c, and 13d each are substantially flat surfaces. Each of a pair of bottom surface 11 and top surface 12, a pair of side surface 13a and side surface 13b, and a pair of side surface 13c and side surface 13d is a pair of surfaces which are parallel to each other. Bottom surface 11 and top surface 12 and side surfaces 13a, 13b, 13c, and 13d extend in intersecting directions, and specifically in orthogonal directions. Side surface 13a and side surface 13b and side surface 13c and side surface 13d extend in intersecting directions, and specifically in orthogonal directions.

The coil element includes coil 21 which is embedded in magnetic core 10 and is formed with one bare wire and a plurality of drawing portions 22 which are exposed to the outside of magnetic core 10 according to both ends of the bare wire. In other words, the coil element in the embodiment includes one coil 21 and two drawing portions 22. In FIG. 1, coil 21 which is embedded is indicated by broken lines.

The coil element is formed with, for example, a conductive wire. The conductive wire includes, for example, a metallic wire which is formed of a metallic material selected from metals such as aluminum, copper, silver, and gold, alloys containing one or more of these metals, a material made of a metal or an alloy and another material and the like and an insulting film which covers the metallic wire. Specifically, the conductive wire is, for example, a copper wire which is covered with the insulating film. Coil 21 and drawing portion 22 are, for example, names which are given to parts formed by processing one member made of the same material.

Coil 21 is a part which is covered by magnetic core 10. Coil 21 is formed with the conductive wire which is wound, and functions as a coil. The number of times coil 21 is wound is not particularly limited, and the number of times such as 0.5 to 10 turns is selected as necessary according to performance required for inductor 100 and restrictions such as the size of magnetic core 10. The conductive wire of coil 21 is, for example, a rectangular wire with sides of 3.2 mm×2.4 mm in cross section. In coil 21, the conductive wire is wound vertically by stacking surfaces including the long sides of the cross section of the conductive wire. Coil 21 is embedded in magnetic core 10 such that the winding axis of coil 21 is along a direction (Z axis direction) connecting bottom surface 11 and top surface 12.

Coil 21 includes ends (not shown) which are connected from the wound part to side surface 13c of magnetic core 10. One of the ends of coil 21 is disposed close to a right outer side relative to the winding axis, that is, on the positive side of the X axis, and the other end is disposed close to a left outer side relative to the winding axis, that is, on the negative side of the X axis when viewed in a direction perpendicular to side surface 13c. The ends of coil 21 are located at heights on the side of bottom surface 11 relative to the center of side surface 13c when viewed in the direction perpendicular to side surface 13c, and the heights from bottom surface 11 are the same.

Drawing portions 22 are connected to the ends of coil 21, are drawn out from side surface 13c of magnetic core 10, and are extended along side plate portion 35 or side surface 13c.

Specifically, each of drawing portions 22 is drawn from the height on the side of bottom surface 11 relative to the center of side surface 13c, and a surface which includes the long sides of the cross section of drawing portion 22 is bent parallel to side plate portion 35 of electrode member 30 so as to be opposite side surface 13c, is extended in the direction (Z axis direction) connecting bottom surface 11 and top surface 12 and is terminated before reaching an edge on the side of top surface 12. Drawing portions 22 in the present embodiment are drawn from one side surface 13c among the four side surfaces.

As shown in FIGS. 1 and 2, electrode member 30 is disposed on the outside of magnetic core 10 (for example, on the side of bottom surface 11, on the side of side surface 13c, and on the side of side surface 13d), and are electrically connected to drawing portions 22 via the connection portion. Electrode member 30 is provided according to two drawing portions 22. Electrode member 30 includes a conductive material, and is formed with, for example, a metallic material plate. The metallic material plate is formed of a metallic material selected from metals such as aluminum, copper, silver, and gold, alloys containing one or more of these metals, a material made of a metal or an alloy and another material and the like.

Electrode member 30 includes: bottom plate portion 31 which is disposed on the side of bottom surface 11 of magnetic core 10; side plate portion 35 which is connected to bottom plate portion 31 and is disposed on the side of side surface 13c of magnetic core 10; and locking portion 38 which is connected to bottom plate portion 31 and is disposed on the side of side surface 13d of magnetic core 10. Side plate portion 35 includes first protrusion plate portion 36i and second protrusion plate portion 36ii which are connected to side plate portion 35. Bottom plate portion 31, side plate portion 35, locking portion 38, first protrusion plate portion 36i, and second protrusion plate portion 36ii are, for example, names which are given to parts formed by processing one member made of the same material.

Bottom plate portion 31 is disposed on the side of bottom surface 11 of magnetic core 10 so as to extend along bottom surface 11. Bottom plate portion 31 may be fixed to magnetic core 10 via an adhesive. Bottom plate portion 31 is joined to a circuit board by solder when inductor 100 is mounted on the circuit board. In bottom plate portion 31, a part which projects to the outside of magnetic core 10 when viewed from the side of top surface 12 (in plan view in the Z axis direction) may be provided, and it is desirable that when soldering is performed in a reflow oven, the projecting part can easily be warmed by the preheating of the reflow oven, and thus solderability is enhanced.

Side plate portion 35 is connected to bottom plate portion 31, and is disposed along side surface 13c of magnetic core 10. Side plate portion 35 in the present embodiment is extended from bottom plate portion 31 to the side of top surface 12. Side plate portion 35 includes openings which penetrate in the direction of thickness and can be penetrated by drawing portions 22, drawing portions 22 are caused to penetrate the openings, and thus drawing portions 22 are disposed along side surface 13c. Side plate portion 35 is disposed between side surface 13c of magnetic core 10 and drawing portions 22 when viewed in the X axis direction, and side plate portion 35 is disposed around drawing portions 22 when viewed in the Y axis direction. Side plate portion 35 is disposed according to one side surface 13c among the four side surfaces. Side plate portion 35 may be fixed to magnetic core 10 via an adhesive.

First protrusion plate portion 36i and second protrusion plate portion 36ii are connected to the opening edge of side plate portion 35, and protrude in a direction away from side surface 13c of magnetic core 10. First protrusion plate portion 36i and second protrusion plate portion 36ii protrude perpendicular to side plate portion 35 or protrude to approach drawing portion 22 from the opening edge of side plate portion 35. First protrusion plate portion 36i and second protrusion plate portion 36ii include an edge which is located on a side opposite to side surface 13c, and at least a part of the edge is in contact with drawing portion 22 along the direction of extension of drawing portion 22.

Drawing portion 22 includes a covering region which has an insulating film on the outer periphery of drawing portion 22 and an exposed region in which the metallic wire is exposed without provision of the insulating film. All or most of the exposed region is provided on the side on which first protrusion plate portion 36i and second protrusion plate portion 36ii are disposed.

An edge of first protrusion plate portion 36i and second protrusion plate portion 36ii is in contact with the exposed region. The connection portion is formed in a part where the exposed region and the edge of first protrusion plate portion 36i and second protrusion plate portion 36ii are in contact with each other.

As shown in FIG. 1, the connection portion is formed by welding drawing portion 22 and the edge of first protrusion plate portion 36i and second protrusion plate portion 36ii. For example, the connection portion as described above is formed with a plurality of welding spots ws which are formed by laser seam welding, and the welding spots ws are connected along the direction of extension of drawing portion 22. All the welding spots ws may be continuously connected or a part of the welding spots ws may be continuously connected.

For example, the length of the connection portion in the direction of extension of drawing portion 22 is longer than the long side of the cross section of the conductive wire in drawing portion 22, and is less than or equal to five times the length of the long side. As the length of the connection portion is increased, the cross-sectional area of the welded part is increased.

In the present embodiment, the edge of first protrusion plate portion 36i and second protrusion plate portion 36ii is in contact with drawing portion 22 along the direction of extension of drawing portion 22. Hence, the length of the connection portion formed by welding the edge and drawing portion 22 can be increased. In this way, the cross-sectional area of the connection portion which connects coil element 22 and electrode member 30 can be increased, and thus the reliability of the connection can be enhanced. The cross-sectional area of a current path in the connection portion can also be increased, and thus direct current resistance can be decreased, with the result that the reliability of the inductor can be enhanced. The cross-sectional area of the current path in the connection portion can be increased, and thus the occurrence of a temperature rise when the inductor is energized is suppressed, with the result that the reliability of the inductor can be enhanced.

Although the half of inductor 100 on the negative side of the X axis will be mainly described below, the half of inductor 100 on the positive side of the X axis has the same structure as the half of inductor 100 on the negative side of the X axis, and thus the same description is applied.

As shown in FIG. 2, electrode member 30 includes locking portion 38 on a part along side surface 13d. More specifically, locking portion 38 is connected to bottom plate portion 31 and is disposed along side surface 13d of magnetic core 10. Locking portion 38 in the present embodiment is extended from bottom plate portion 31 to the side of top surface 12 and is disposed between the outermost part of side surface 13d of magnetic core 10 and the innermost part thereof when viewed in the X axis direction. Locking portion 38 is disposed according to one side surface 13d among the four side surfaces. In locking portion 38, openings 38a are formed. Openings 38a are through holes in a quadrilateral shape which are provided to penetrate electrode member 30 in the direction of thickness (here, the Y axis direction). Openings 38a correspond to projections 131d formed on side surface 13d, and locking portion 38 is disposed such that projections 131d penetrate openings 38a. Locking portion 38 may be fixed to magnetic core 10 via an adhesive. The side surface of projection 131d on the side of top surface 12 and the inner side surface of opening 38a on the side of top surface 12 (opposite the side of bottom surface 11) are locked to each other, and thus locking portion 38 as described above is utilized for fixing magnetic core 10 and electrode member 30. In other words, electrode member 30 is fixed to magnetic core 10 by the locking of locking portion 38 to projections 131d and the welding in the connection portion (the adhesion of bottom plate portion 31, side plate portion 35, and locking portion 38 depending on the case). For example, as shown in the figure, projections 131d as described above are formed on the side of bottom surface 11 relative to the center of magnetic core 10.

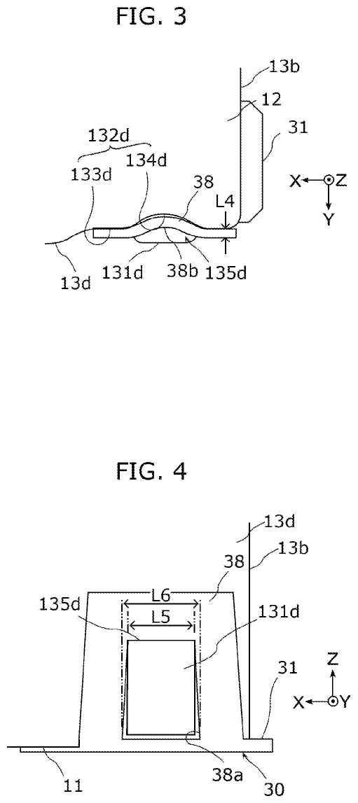

Here, FIG. 3 is a top view of a part of the inductor according to the embodiment. FIG. 3 shows the part of inductor 100 when viewed from the side of top surface 12 (in plan view in the Z axis direction) with locking portion 38 in the center. As shown in FIG. 3, projection 131d protrudes vertically (here, to the positive side in the Y axis direction) from the side surface. Recess 132d is formed around projection 131d to surround projection 131d. Projection 131d penetrates opening 38a, and thus locking portion 38 is disposed more inward of magnetic core 10 than the outmost surface of projection 131d. Locking portion 38 makes contact with recess 132d so as not to further enter the inside of magnetic core 10. Part 134d of recess 132d is further recessed inward of magnetic core 10 in a position corresponding to locking surface 135d to which locking portion 38 is locked and which is the side surface of projection 131d on the side of top surface 12.

Hence, recess 132d includes part 134d which is recessed more inward of magnetic core 10 than other part 133d. Part 134d of recess 132d includes a curved surface in which a depth toward the interior of magnetic core 10 in a recess shape smoothly changes. Locking portion 38 includes swaged portion 38b which is bent in a smoothly curved shape along the curved surface. Swaged portion 38b is bent to enter part 134d of recess 132d, and thus tensile resistance of locking portion 38 in the Z axis direction is enhanced. Furthermore, swaged portion 38b is provided, and thus the quadrilateral shape of opening 38a is deformed as shown in FIG. 4.

FIG. 4 is a side view of a part of the inductor according to the embodiment. FIG. 4 shows the part of inductor 100 when viewed from the side of side surface 13d (in plan view in the Y axis direction) with locking portion 38 in the center. As shown in FIG. 4, one side of the quadrilateral shape of opening 38a corresponding to locking surface 135d is tightened in the X axis direction to be narrowed, and thus the one side is shorter than a side opposite the one side. Specifically, when the length of the side corresponding to locking surface 135d is L5, L5 is shorter than length L6 of the opposite side. Hence, the quadrilateral shape of opening 38a is a so-called trapezoidal shape, and the inner side surface of opening 38a on the side of side surface 13a and the inner side surface of opening 38a on the side of side surface 13b make contact with projection 131d so as to sandwich projection 131d, with the result that resistance to displacement of locking portion 38 in the Y axis direction is enhanced.

In order to ensure the locking of locking portion 38, a sufficient length of locking surface 135d of projection 131d in a direction along the plate surface of electrode member 30 is provided. For example, locking portion 38 is designed such that length L5 of the side corresponding to locking surface 135d is sufficient for thickness L4 (thickness of electrode member 30) of locking portion 38 shown in FIG. 3. L5 is, for example, greater than or equal to twice L4.

With reference back to FIG. 2, bottom plate portion 31 includes bottom surface swaged portion 31a. By bottom surface swaged portion 31a, the length of bottom plate portion 31 in the Y axis direction is tightened to be narrowed, and thus the locking of locking portion 38 to projection 131d can be strengthened. In magnetic core 10, bottom surface recess 11a which is recessed inward of magnetic core 10 is formed in a position in which bottom surface 11 overlaps bottom plate portion 31 of electrode member 30 so that bottom surface swaged portion 31a is formed in bottom surface 11. Bottom plate portion 31 enters the interior of magnetic core 10 along the recess shape of bottom surface recess 11a, and is curved, and thus bottom surface swaged portion 31a is formed.

Regarding the width of electrode member 30 in bottom plate portion 31 (length of electrode member 30 extending in the Y axis direction in the X axis direction), for example, width L2 in the position of bottom surface swaged portion 31a is narrower than the other parts (for example, length L1). In this way, bottom surface swaged portion 31a can be formed with smaller stress, and the narrowing of the length of bottom plate portion 31 when bottom surface swaged portion 31a is formed is efficiently transmitted to swaged portion 38b and the like, with the result that the fixing of electrode member 30 to magnetic core 10 is further strengthened.

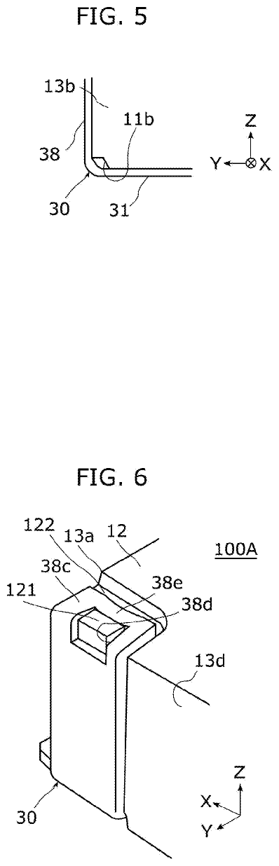

Here, FIG. 5 is another side view of a part of the inductor according to the embodiment. FIG. 5 shows the part of inductor 100 when viewed from the side of side surface 13b (in plan view in the X axis direction) with locking portion 38 and bottom plate portion 31 in the center. As shown in FIG. 5, in magnetic core 10, cavity 11b which is recessed inward of magnetic core 10 is formed in a boundary connecting magnetic core 10 and side surface 13d and in a position in which magnetic core 10 overlaps electrode member 30. Cavity 11b is formed to provide play, and thus the narrowing of bottom plate portion 31 caused by bottom surface swaged portion 31a is unlikely to be inhibited in a boundary part, with the result that it is possible to more efficiently exert the effect of bottom surface swaged portion 31a on locking portion 38.

With reference back to FIG. 2, the area of bottom plate portion 31 on the side of side surface 13c (part 31b in the figure) relative to the position of bottom surface swaged portion 31a is larger than the area of bottom plate portion 31 on the side of side surface 13d (part 31c in the figure) relative to the position of bottom surface swaged portion 31a. The width of bottom surface swaged portion 31a is narrowed, and thus a part of high electrical resistance is formed between the side of part 31b and the side of part 31c. Hence, on the side of drawing portion 22 relative to the part of high electrical resistance as described above, part 31b of a large area is provided, and thus it is possible to suppress deterioration of current-carrying characteristics.

### [Manufacturing Method]

A method for manufacturing inductor 100 described above will then be described. The manufacturing of inductor 100 according to the embodiment is performed as described below. The method for manufacturing inductor 100 is not limited to an example below.

In the method for manufacturing inductor 100, a step of pressure-forming magnetic core 10 together with the coil element is first performed. The step described above is performed by putting the coil element having coil 21 into a forming die and pressure-forming a powder compacting magnetic core. A pressure during pressure forming is, for example, 5 ton/cm², and a thermosetting temperature is, for example, 185° C. Drawing portions 22 which are not covered by magnetic core 10 and are exposed after pressure forming protrude perpendicular to side surface 13c of magnetic core 10.

Then, a step of forming the exposed region on the outer periphery of drawing portion 22 is performed. The exposed region is formed by removing, after pressure forming, a part of the insulating film by laser irradiation or the like.

Then, a step of bending drawing portions 22 exposed from magnetic core 10 along side surface 13c is performed. Specifically, drawing portions 22 are formed so as to extend in a direction connecting bottom surface 11 and top surface 12 from a root located on side 13c or are formed such that a surface including the long sides of the cross section of drawing portion 22 is opposite side surface 13c.

Then, a step of preparing electrode member 30 including bottom plate portion 31, side plate portion 35, and locking portion 38 by punching and bending the metallic material plate is performed.

In this step, first protrusion plate portion 36i and second protrusion plate portion 36ii of side plate portion 35 are previously bent in a direction away from side surface 13c of magnetic core 10. A boundary portion between bottom plate portion 31 and side plate portion 35 and a boundary portion between bottom plate portion 31 and locking portion 38 each may be preliminarily bent such that the internal angle is about 100° to 110°.

Then, a step of disposing electrode member 30 on magnetic core 10 as shown in FIG. 1 is performed. Bottom plate portion 31 is disposed on bottom surface 11 of magnetic core 10, side plate portion 35 is bent along side surface 13c of magnetic core 10, and locking portion 38 is bent along side surface 13d of magnetic core 10. Here, drawing portions 22 are caused to penetrate the openings of side plate portion 35, and thus drawing portion 22 and the edge of first protrusion plate portion 36i and second protrusion plate portion 36ii are brought into contact with each other. Projections 131d are caused to penetrate openings 38a of locking portion 38. When any or all of bottom plate portion 31, side plate portion 35, and locking portion 38 of electrode member 30 are adhered to magnetic core 10, in this step, a thermosetting adhesive which is viscous when uncured is previously applied to the part at which electrode member 30 and magnetic core 10 are brought into contact with each other. The curing of the adhesive is performed not in this step but in a step described later.

Then, a step of welding the edge of first protrusion plate portion 36i and second protrusion plate portion 36ii and drawing portion 22 by laser seam welding or the like is performed. Specifically, the connection portion is formed along the direction of extension of drawing portion 22. The welding spots ws formed in the connection portion are circular, and are formed, for example, by rotating and moving the spot of a laser beam at a predetermined radius. Here, the welding is performed in a state where bottom plate portion 31 of electrode member 30 is pressed to bottom surface 11 of magnetic core 10, side plate portion 35 of electrode member 30 is pressed to side surface 13c of magnetic core 10, and locking portion 38 of electrode member 30 is pressed to side surface 13d of magnetic core 10. In this way, drawing portions 22 and electrode member 30 are electrically connected, and electrode member 30 is mechanically fixed to magnetic core 10.

Then, a step of bending locking portion 38 such that locking portion 38 enters parts 134d of recesses 132d of magnetic core 10 is performed. In this way, swaged portions 38b are formed, and thus the narrowing of openings 38a of locking portion 38 is performed.

Then, a step of bending bottom plate portion 31 such that bottom plate portion 31 enters bottom surface recess 11a of magnetic core 10 is performed. In this way, bottom surface swaged portion 31a is formed, and thus the narrowing of electrode member 30 is performed. As described above, swaged portion 38b and bottom surface swaged portion 31a are formed in this order to perform the narrowing of electrode member 30, and thus entire electrode member 30 is tightened to magnetic core 10, with the result that electrode member 30 and magnetic core 10 are securely fixed. When electrode member 30 is adhered to magnetic core 10, after this step, a step of performing heating treatment to cure the adhesive is performed. After the narrowing is performed with swaged portion 38b and bottom surface swaged portion 31a, the curing of the adhesive is performed, and thus until the adhesive is cured, by the viscosity of the uncured adhesive, electrode member 30 can be efficiently tightened to magnetic core 10 with swaged portion 38b and bottom surface swaged portion 31a, with the result that after the curing of the adhesive, the fixing power of electrode member 30 and magnetic core 10 can be strengthened by the adhesive power of the adhesive. In this way, inductor 100 is manufactured.

### Effects and Like

As described above, inductor 100 according to a first aspect of the present embodiment includes: magnetic core 10 that includes a magnetic material, bottom surface 11, top surface 12, and side surface 13a to 13d connected to bottom surface 11 and top surface 12; a coil element that includes coil 21 which is embedded in magnetic core 10 and drawing portion 22 which is connected to an end of coil 21 and is drawn from side surface 13c to the outside of magnetic core 10; and electrode member 30 that is plate-shaped, disposed on side surfaces 13c and 13d and bottom surface 11, and electrically connected to the coil element via drawing portion 22, magnetic core 10 includes projection 131d that protrudes in a direction perpendicular to at least one of side surface 13d or top surface 12 and recess 132d that surrounds projection 131d and is recessed more inward of magnetic core 10 than projection 131d, and electrode member 30 includes locking portion 38 that includes opening 38a which penetrates, in accordance with projection 131d, electrode member 30 in the direction of thickness of electrode member 30, and locking portion 38 enters recess 132d to be locked to locking surface 135d connecting projection 131d and recess 132d.

In inductor 100 as described above, locking portion 38 of electrode member 30 is locked to projection 131d of magnetic core 10, and thus the falling off of magnetic core 10 from electrode member 30 is suppressed. In particular, in a direction in which locking surface 135d overlaps the inner side surface of opening 38a, a force acting in a direction in which magnetic core 10 separates from electrode member 30 is suppressed by the locking, and thus it is possible to realize inductor 100 which has high resistance in the direction in which locking surface 135d overlaps the inner side surface of opening 38a. As described above, the falling off of magnetic core 10 from electrode member 30 is suppressed, and thus the reliability of the connection of electrode member 30 and the coil element partially embedded in magnetic core 10 is enhanced, with the result that the more reliable inductor can be realized.

Inductor 100 according to a second aspect of the present disclosure is inductor 100 according to the first aspect in which projection 131d protrudes in the direction perpendicular to side surface 13d.

In this way, it is possible to realize inductor 100 which has high resistance in a direction parallel to side surface 13d.

Inductor 100 according to a third aspect of the present disclosure is inductor 100 according to the second aspect in which projection 131d protrudes in the direction perpendicular to side surface 13d, and is formed on the side of bottom surface 11 relative to the center of magnetic core 10 in a direction connecting bottom surface 11 and top surface 12.

In this way, electrode member 30 is fixed to the side of bottom surface 11 relative to the center of gravity of magnetic core 10, and thus it is possible to increase the self-resonant frequency of inductor 100 for vibration. Hence, magnetic core 10 is unlikely to vibrate relative to electrode member 30, and thus the falling off of magnetic core 10 from electrode member 30 is suppressed.

Inductor 100A according to a fourth aspect will be described later.

Inductor 100 according to a fifth aspect of the present disclosure is the same as inductors 100 according to the first to third aspects or inductor 100A according to the fourth aspect except that the length of locking surface 135d of projection 131d in a direction along a plate surface of electrode member 30 is greater than or equal to twice the length of electrode member 30 in the direction of thickness.

In this way, in the fixing of electrode member 30 and magnetic core 10 by locking of locking portion 38 to projection 131d, sufficient resistance for preventing projection 131d of side surface 13d from being damaged can be provided.

Inductor 100 according to a sixth aspect of the present disclosure is the same as inductors 100 according to the first to third and the fifth aspects or inductor 100A according to the fourth aspect except that part 134d of recess 132d that is directly connected to locking surface 135d is recessed more inward of magnetic core 10 than other part 133d, locking portion 38 includes swaged portion 38b that is bent in accordance with part 134d of recess 132d, and swaged portion 38b is located more inward of magnetic core 10 than other part 133d of recess 132d.

In this way, the area of the inner side surface of opening 38a which is locked to locking surface 135d can be increased toward the depth of part 134d. Since the side of the end of locking portion 38 is configured three-dimensionally as compared with opening 38a, and thus the rigidity thereof is enhanced, it is possible to realize the inductor which has resistance to a larger force for falling off magnetic core 10.

Inductor 100 according to a seventh aspect of the present disclosure is inductor 100 according to the sixth aspect in which part 134d of recess 132d includes a curved surface in which a depth toward the interior of magnetic core 10 in a recess shape smoothly changes, and swaged portion 38b is smoothly curved along the curved surface.

In this way, as compared with a case where swaged portion 38b is formed by bending electrode member 30, electrode member 30 is unlikely to be damaged due to swaged portion 38b.

Inductor 100 according to an eighth aspect of the present disclosure is inductor 100 according to the sixth or seventh aspect in which opening 38a is in a quadrilateral shape when viewed in the direction of thickness, and among four sides of the quadrilateral shape, the length of a side corresponding to locking surface 135d is shorter than the length of a side opposite the side.

In this way, opening 38a in a trapezoidal shape can be formed. A force that is applied in the direction in which locking surface 135d overlaps the inner side surface of opening 38a when locking portion 38 is locked can be utilized for locating opening 38a and projection 131d. Opening 38a can be tightened in a direction in which projection 131d is sandwiched, and thus it is possible to suppress the falling off of opening 38a from projection 131d.

Inductor 100 according to a ninth aspect of the present disclosure is the same as inductors 100 according to the first to third and fifth to eight aspects or inductor 100A according to the fourth aspect except that magnetic core 10 includes bottom surface recess 11a of bottom surface 11 that is recessed inward of magnetic core 10 in a position in which bottom surface 11 overlaps electrode member 30, and electrode member 30 includes bottom surface swaged portion 31a that is recessed toward bottom surface recess 11a and is bent in accordance with bottom surface recess 11a.

In this way, by bottom surface swaged portion 31a, the length of bottom plate portion 31 in the in-plane direction of bottom surface 11 can be reduced. Hence, electrode member 30 can be tightened in a direction in which a distance between locking portion 38 and a connection part to drawing portion 22 is reduced, and thus the locking of locking portion 38 to projection 131d can be further strengthened.

Inductor 100 according to a tenth aspect of the present disclosure is inductor 100 according to the ninth aspect in which in a part of electrode member 30 disposed on bottom surface 11, the width of the part in the position of bottom surface swaged portion 31a is narrowest.

In this way, it is possible to decrease stress necessary for forming bottom surface swaged portion 31a.

Inductor 100 according to an eleventh aspect of the present disclosure is inductor 100 according to the ninth or tenth aspect in which when among side surfaces 13a to 13d, side surface 13d located closest to projection 131d is a first side surface, and side surface 13c located farthest from projection 131d is a second side surface, drawing portion 22 and electrode member 30 are welded on the second side surface to be electrically connected, and in a part of electrode member 30 disposed on bottom surface 11, the area of the part on the side of the second side surface relative to the position of bottom surface swaged portion 31a is larger than the area of the part on the side of the first side surface relative to the position of bottom surface swaged portion 31a.

In this way, the electrode part of a large area can be provided on the side of drawing portion 22 without intervention of bottom surface swaged portion 31a of a narrow width and relatively high electrical resistance.

Inductor 100 according to a twelfth aspect of the present disclosure is inductor 100 according to any one of the ninth to eleventh aspects in which magnetic core 10 includes cavity 11b that is recessed inward of magnetic core 10 in a boundary connecting bottom surface 11 and side surface 13d and in the position in which magnetic core 10 overlaps electrode member 30.

In this way, as compared with a case where cavity 11b is not provided, it is possible to decrease snagging caused by formation of bottom surface swaged portion 31a when locking portion 38 is pulled to the side of bottom plate portion 31. In other words, a force that is caused by formation of bottom surface swaged portion 31a and tightens electrode member 30 in the direction in which the distance between locking portion 38 and the connection part to drawing portion 22 is reduced can be transmitted to locking portion 38 with low loss.

### Variation of Embodiment

An inductor according to a variation of the embodiment will be described below. In the variation, differences from the embodiment will be mainly described below, and description of common configurations is omitted or simplified.

### [Variation]

Inductor 100A according to the variation of the embodiment will be described. In the variation, an example where inductor 100A includes a projection on the side of top surface 12 will be described.

FIG. 6 is a diagram illustrating the projection in the inductor according to the variation of the embodiment. FIG. 6 shows a perspective view showing an end of inductor 100A according to the variation on the positive side in the X axis direction and on the positive side in the Y axis direction.

Inductor 100A according to the variation differs from the embodiment described above in that instead of projection 131d formed on side surface 13d of inductor 100 according to the embodiment, projection 121 is formed on top surface 12. Projection 121 is surrounded by recess 122, and penetrates opening 38d formed in locking portion 38c extending along side surface 13d to top surface 12. The inner side surface of opening 38d on the positive side in the Y axis direction is locked to the side surface of projection 121 on the negative side in the Y axis direction, and thus locking portion 38c is locked to projection 121. In this way, locking portion 38c is unlikely to be disconnected from magnetic core 10, and thus electrode member 30 and magnetic core 10 are securely fixed. In inductor 100A according to the variation, swaged portion 38e may also be formed. A part of recess 122 is further recessed inward of magnetic core 10 in a position corresponding to a locking surface to which locking portion 38c is locked and which is the side surface of projection 121 on the side of side surface 13c. Hence, recess 122 includes the part which is recessed more inward of magnetic core 10 than the other part. The part of recess 122 includes a curved surface in which a depth toward the interior of magnetic core 10 in a recess shape smoothly changes. Swaged portion 38e is a part of locking portion 38c which is bent in a smoothly curved shape along the curved surface. Swaged portion 38e is bent to enter the part of recess 122, and thus tensile resistance of locking portion 38c in the Y axis direction is enhanced. Furthermore, swaged portion 38e is provided, and thus opening 38d is in a quadrilateral shape when viewed from the side of top surface 12.

As described above, inductor 100A according to the fourth aspect of the present embodiment is the same as inductor 100 according to the first aspect except that projection 121 protrudes in the direction perpendicular to the top surface.

By inductor 100A as described above, it is possible to realize inductor 100 which has high resistance in a direction parallel to top surface 12.

### Other Embodiments and Like

Although the inductors according to the embodiment of the present disclosure and the variation and the like have been described above, the present disclosure is not limited to the embodiment and the variation. Embodiments obtained by performing various variations conceived by those skilled in the art on the embodiment and the variation and embodiments established by combining some constituent elements in the embodiment and the variation are also included in the scope of the present disclosure as long as they do not depart from the spirit of the present disclosure.

Although in the embodiment described above, the example is shown where bottom plate portion 31, side plate portion 35, first protrusion plate portion 36i, second protrusion plate portion 36ii, and locking portion 38 of electrode member 30 are formed by processing one member made of the same material, the present disclosure is not limited to this configuration. For example, electrode member 30 may be formed by connecting bottom plate portion 31, side plate portion 35, first protrusion plate portion 36i, second protrusion plate portion 36ii, and locking portion 38 made of different members.

Although in the embodiment described above, the example is shown where coil 21 and drawing portions 22 of the coil element are formed by processing one member made of the same material, the present disclosure is not limited to this configuration. The coil element may be formed by connecting coil 21 and drawing portions 22 made of different members.

Although in the embodiment described above, the example is shown where the cross section of the conductive wire is rectangular, the present disclosure is not limited to this configuration. The cross section of the conductive wire may be circular, and at least a part of drawing portion 22 may be expanded in the shape of a flat plate so as to be easily connected to electrode member 30.

Although in the embodiment described above, the example is shown where drawing portion 22 is drawn from the height on the side of bottom surface 11 relative to the center of side surface 13c and is extended in the direction toward the side of top surface 12, the present disclosure is not limited to this configuration. Drawing portion 22 may be drawn from a height on the side of top surface 12 relative to the center of side surface 13c and may be extended in the direction toward the side of bottom surface 11. In this case, a configuration may be adopted in which in side plate portion 35, no opening is provided, side plate portion 35 is interposed between drawing portions 22 and side surface 13c, and first protrusion plate portion 36i and second protrusion plate portion 36ii are provided on the edge of side plate portion 35.

Although in the embodiment described above, the example is shown where first protrusion plate portion 36i and second protrusion plate portion 36ii are disposed on both sides in the direction of extension of drawing portion 22, the present disclosure is not limited to this configuration. First protrusion plate portion 36i and second protrusion plate portion 36ii may be disposed only on one side in the direction of extension of drawing portion 22.

Although in the embodiment described above, the example is shown where two protrusion plate portions, that is, first protrusion plate portion 36i and second protrusion plate portion 36ii are provided on side plate portion 35, the present disclosure is not limited to this configuration. One or three protrusion plate portions may be provided.

For example, electrical products or electrical circuits which use the inductors described above are also included in the present disclosure. Examples of the electrical product include power supply devices which include the inductors described above, various types of appliances which include the power supply devices and the like.

### INDUSTRIAL APPLICABILITY

The inductors according to the present disclosure are useful as inductors which are used in various types of devices and appliances and the like.

### REFERENCE SIGNS LIST

10 magnetic core
11 bottom surface
11a bottom surface recess
11b cavity
12 top surface
13a, 13b, 13c, 13d side surface
21 coil
22 drawing portion
30 electrode member
31 bottom plate portion
31a bottom surface swaged portion
31b, 31c part
35 side plate portion
36i first protrusion plate portion
36ii second protrusion plate portion
38, 38c locking portion
38a, 38d opening
38b, 38e swaged portion
100, 100A inductor
121, 131d projection
122, 132d recess
133d other part
134d part
135d locking surface
ws welding spot

1. An inductor comprising:
a magnetic core that includes a magnetic material, a bottom surface, a top surface, and a side surface connected to the bottom surface and the top surface;
a coil element that includes
a coil which is embedded in the magnetic core and
a drawing portion which is connected to an end of the coil and is drawn from the side surface to an outside of the magnetic core; and
an electrode member that is plate-shaped, disposed on the side surface and the bottom surface, and electrically connected to the coil element via the drawing portion,
wherein the magnetic core includes
a projection that protrudes in a direction perpendicular to at least one of the side surface or the top surface and
a recess that surrounds the projection and is recessed more inward of the magnetic core than the projection, and
the electrode member includes a locking portion that includes an opening which penetrates, in accordance with the projection, the electrode member in a direction of thickness of the electrode member, and the locking portion enters the recess to be locked to a locking surface connecting the projection and the recess.

2. The inductor according to claim 1,
wherein the projection protrudes in the direction perpendicular to the side surface.

3. The inductor according to claim 2,
wherein the projection protrudes in the direction perpendicular to the side surface, and is formed on a side of the bottom surface relative to a center of the magnetic core in a direction connecting the bottom surface and the top surface.

4. The inductor according to claim 1,
wherein the projection protrudes in the direction perpendicular to the top surface.

5. The inductor according to claim 1,
wherein a length of the locking surface of the projection in a direction along a plate surface of the electrode member is greater than or equal to twice a length of the electrode member in the direction of thickness.

6. The inductor according to claim 1,
wherein a part of the recess that is directly connected to the locking surface is recessed more inward of the magnetic core than an other part,
the locking portion includes a swaged portion that is bent in accordance with the part of the recess, and
the swaged portion is located more inward of the magnetic core than the other part of the recess.

7. The inductor according to claim 6,
wherein the part of the recess includes a curved surface in which a depth toward an interior of the magnetic core in a recess shape smoothly changes, and
the swaged portion is smoothly curved along the curved surface.

8. The inductor according to claim 6,
wherein the opening is in a quadrilateral shape when viewed in the direction of thickness, and
among four sides of the quadrilateral shape, a length of a side corresponding to the locking surface is shorter than a length of a side opposite the side.

9. The inductor according to claim 1,
wherein the magnetic core includes a bottom surface recess in the bottom surface that is recessed inward of the magnetic core in a position in which the bottom surface overlaps the electrode member, and
the electrode member includes a bottom surface swaged portion that is recessed toward the bottom surface recess and is bent in accordance with the bottom surface recess.

10. The inductor according to claim 9,
wherein in a part of the electrode member disposed on the bottom surface, a width of a part in a position of the bottom surface swaged portion is narrowest.

11. The inductor according to claim 9,
wherein when among side surfaces each being the side surface, the side surface located closest to the projection is a first side surface, and the side surface located farthest from the projection is a second side surface,
the drawing portion and the electrode member are welded on the second side surface to be electrically connected, and
in a part of the electrode member disposed on the bottom surface, an area of a part on a side of the second side surface relative to a position of the bottom surface swaged portion is larger than an area of a part on a side of the first side surface relative to the position of the bottom surface swaged portion.

12. The inductor according to claim 9,
wherein the magnetic core includes a cavity that is recessed inward of the magnetic core in a boundary connecting the bottom surface and the side surface and in a position in which the magnetic core overlaps the electrode member.
